(19) United States
(12) Patent Application Publication
(10) Pub. No.: US 2014/0172350 A1
(43) Pub. Date: Jun. 19, 2014

(54) REMOTE SENSOR CONFIGURATION

(71) Applicant: Carrier Corporation, Farmington, CT (US)

(72) Inventor: Jeffrey P. Lothamer, Ft. Wayne, IN (US)

(73) Assignee: Carrier Corporation, Farmington, CT (US)

(21) Appl. No.: 14/108,698

(22) Filed: Dec. 17, 2013

Related U.S. Application Data
(60) Provisional application No. 61/738,671, filed on Dec. 18, 2012.

(51) Int. Cl. G01K 7/22

(52) U.S. Cl. CPC G01K 7/22
USPC 702/133

(57) ABSTRACT

Embodiments are directed to receiving, by a device, an identification of a coupling configuration associated with at least one sensor via a user interface, sensing, by the device, a sensed parameter associated with the at least one sensor, calculating, by the device, a translated parameter based on the sensed parameter, and mapping, by the device, the translated parameter to a temperature.

### CROSS-REFERENCE TO RELATED APPLICATIONS

This application claims the benefit of U.S. provisional patent application Ser. No. 61/738,671, filed Dec. 18, 2012, the entire contents of which are incorporated herein by reference.

### BACKGROUND

Heating and air conditioning applications may use sensors to monitor or regulate temperature in an environment, such as a room or a building. If multiple sensors (e.g., thermistor based room temperature sensors used with a thermostat) are used for averaging multiple zones, or multiple areas in a single zone, the same value or type of sensors must be used in a given wiring configuration in order to ensure that the sensed resistance at the thermostat is equal to the value of resistance associated with a single sensor. Such a requirement reduces flexibility in terms of the number of sensors that may be used as well as the wiring configuration that may be available to a user (e.g., an owner or installer of a thermostat).

### BRIEF SUMMARY

An embodiment of the disclosure is directed to a method comprising: receiving, by a device, an identification of a coupling configuration associated with at least one sensor via a user interface, sensing, by the device, a sensed parameter associated with the at least one sensor, calculating, by the device, a translated parameter based on the sensed parameter, and mapping, by the device, the translated parameter to a temperature.

An embodiment of the disclosure is directed to an apparatus comprising: at least one processor, and memory having instructions stored thereon that, when executed by the at least one processor, cause the apparatus to: receive an identification of a coupling configuration associated with at least one sensor via a user interface, sense a resistance value associated with the at least one sensor, calculate a translated resistance value based on the sensed resistance, and map the translated resistance to a temperature.

An embodiment of the disclosure is directed to a system comprising: a plurality of temperature sensors, and a thermostat remotely located from the plurality of temperature sensors, the thermostat configured to: receive an identification of a number of sensors included in the plurality of temperature sensors and a coupling configuration between the plurality of temperature sensors via a user interface, sense a resistance value associated with the plurality of temperature sensors, calculate a translated resistance value based on the sensed resistance, the number of sensors included in the plurality of temperature sensors, and the coupling configuration, and map the translated resistance to a temperature.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1 is a schematic block diagram illustrating an exemplary computing system in accordance with one or more embodiments of this disclosure;

FIGS. 2A-2C illustrates block diagrams of sensor configurations in accordance with one or more embodiments of this disclosure; and

FIG. 3 is a flow chart of an exemplary method in accordance with one or more embodiments of this disclosure.

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Exemplary embodiments of apparatuses, systems, and methods are described for enabling a user (e.g., an owner or installer) of a thermostat to select or identify a number of sensors that are used and a coupling configuration between the sensors. In some embodiments, the thermostat may calculate a resistance based on the identification of the number of sensors and the coupling configuration. The resistance may be calculated in accordance with a formula. The thermostat may translate or map the calculated resistance to a temperature.

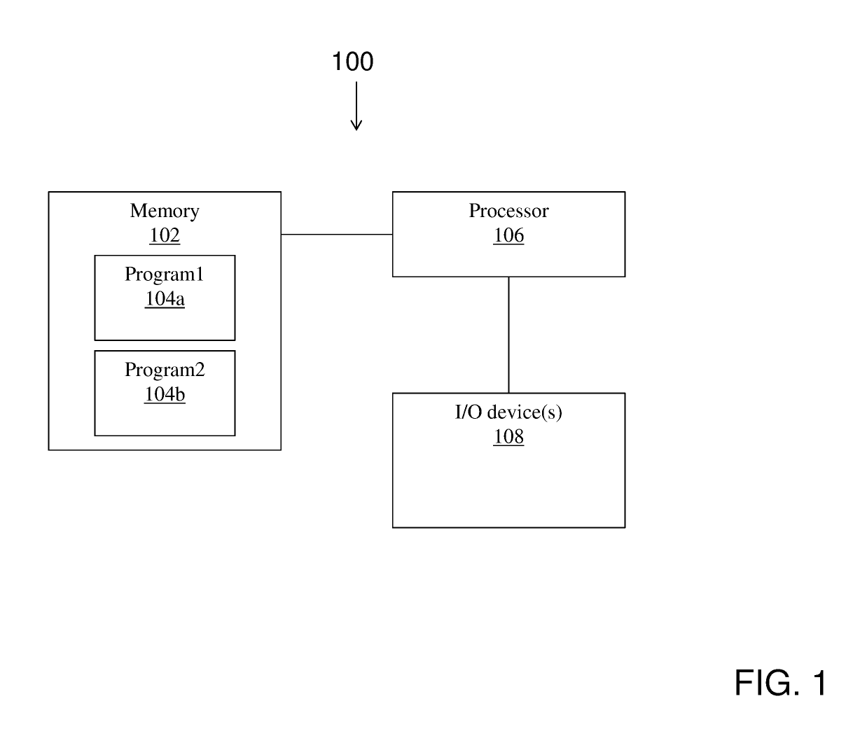

Referring to FIG. 1, an exemplary computing system 100 is shown. The system 100 is shown as including a memory 102. The memory 102 may store executable instructions. The executable instructions may be stored or organized in any manner and at any level of abstraction, such as in connection with one or more processes, routines, methods, etc. As an example, at least a portion of the instructions are shown in FIG. 1 as being associated with a first program 104a and a second program 104b.

The instructions stored in the memory 102 may be executed by one or more processors, such as a processor 106. The processor 106 may be coupled to one or more input/output (I/O) devices 108. In some embodiments, the I/O device(s) 108 may include one or more of a keyboard or keypad, a touchscreen or touch panel, a display device, a microphone, a speaker, a mouse, a button, a remote control, a joystick, a printer, etc. The I/O device(s) 108 may be configured to provide an interface to allow a user to interact with the system 100.

The system 100 is illustrative. In some embodiments, one or more of the entities may be optional. In some embodiments, additional entities not shown may be included. For example, in some embodiments the system 100 may be associated with one or more networks. In some embodiments, the entities may be arranged or organized in a manner different from what is shown in FIG. 1. One or more of the entities shown in FIG. 1 may be associated with one or more of the devices or entities described herein.

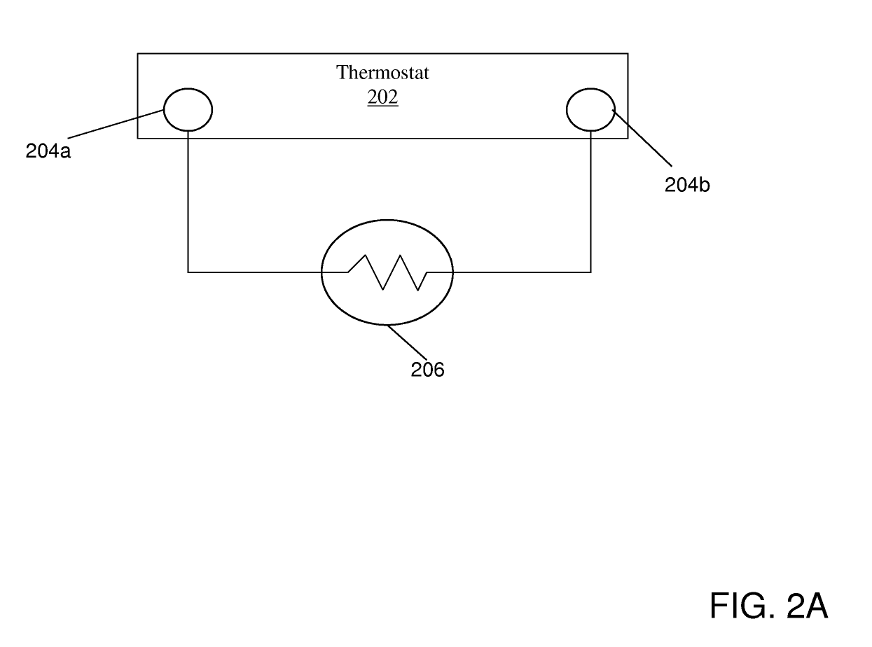

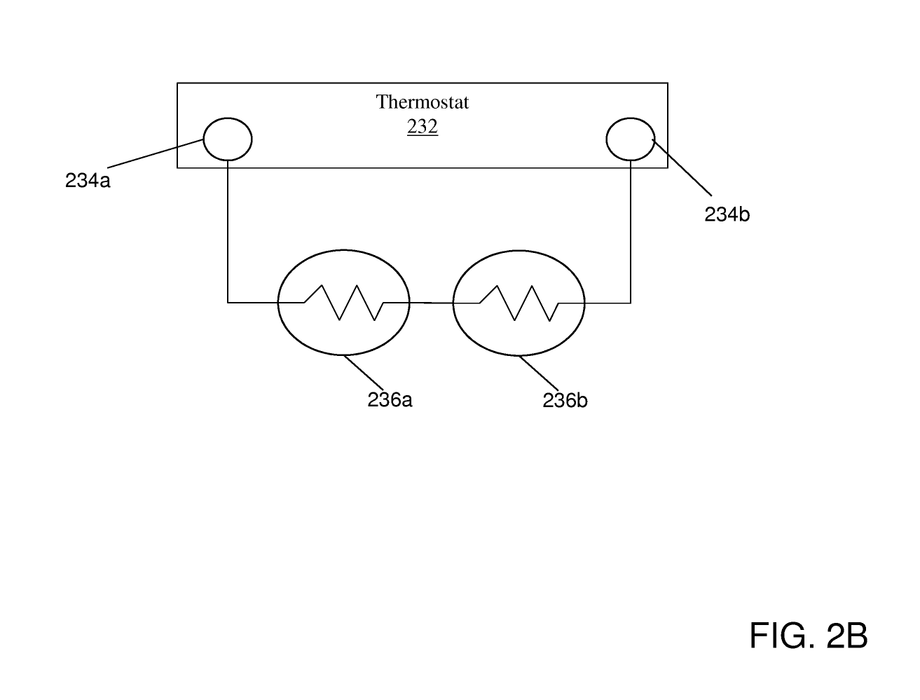

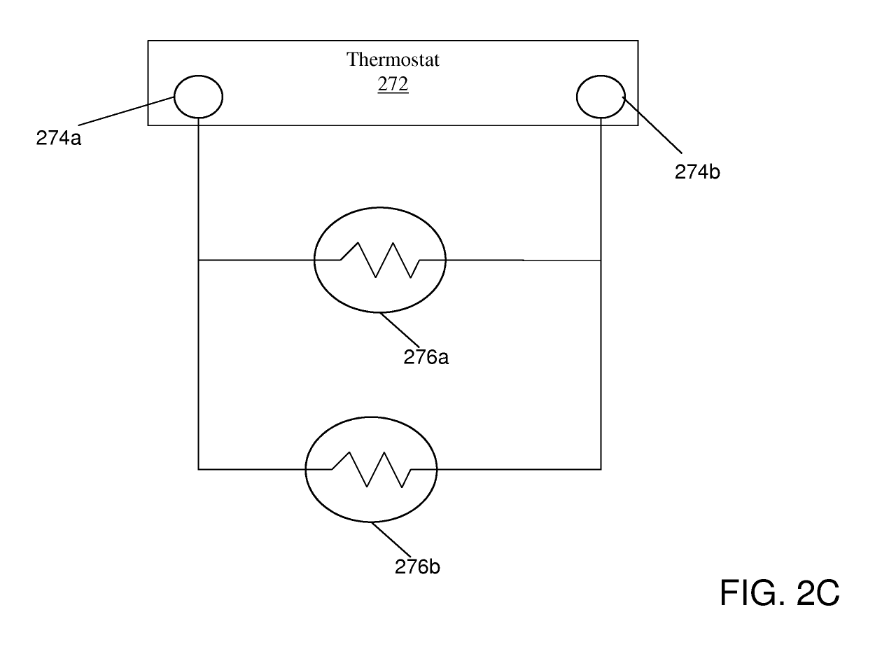

Turning to FIGS. 2A-2C (collectively referred to as FIG. 2 herein), sensor configurations are shown in accordance with one or more embodiments. In FIG. 2A, a thermostat 202 is shown. Thermostat 202 may include a computing system 100. The thermostat may include one or more inputs, such as indoor (ID) inputs 204a and 204b. A resistance may be measured at or across the ID inputs 204a and 204b. The measured resistance may be based on a resistance of a sensor 206. For example, the sensor 206 may be, or include, a thermistor, such that a resistance of the sensor 206 may be indicative of a temperature of a gas proximate to the sensor 206. The sensor 206 may be remotely located from the thermostat 202.

In FIG. 2B, ID inputs 234a and 234b associated with a thermostat 232 are shown as being coupled to sensors 236a and 236b, where sensors 236a and 236b are coupled to one another in series. For purposes of comparison, and assuming that the sensors 206, 236a, and 236b provide the same resistance at a given temperature (e.g., at a nominal temperature of 77 degrees Fahrenheit, each sensor provides 10 Kohm of resistance), the resistance measured at the ID inputs 234a and 234b may be double what is measured at the ID inputs 204a and 204b.

In FIG. 2C, ID inputs 274a and 274b associated with a thermostat 272 are shown as being coupled to sensors 276a and 276b, where sensors 276a and 276b are coupled to one another in parallel. For purposes of comparison, and assuming that the sensors 206, 276a, and 276b provide the same resistance at a given temperature (e.g., at a nominal temperature of 77 degrees Fahrenheit, each sensor provides 10 Kohm of resistance), the resistance measured at the ID inputs 274a and 274b may be half of what is measured at the ID inputs 204a and 204b.

Multiple sensors may be used in some embodiments to obtain an averaging of a temperature sensed by each sensor. For example, in relation to the scenario illustrated and described above in connection with FIG. 2B, the resistance measured at the ID inputs 234a and 234b may be halved or divided by two, and the halved resistance value may be mapped to a resistance-versus-temperature curve to obtain the average temperature. Similarly, in relation to the scenario illustrated and described above in connection with FIG. 2C, the resistance measured at the ID inputs 274a and 274b may be doubled or multiplied by two, and the multiplied resistance value may be mapped to the resistance-versus-temperature curve to obtain the average temperature. More generally, a translation of a resistance value sensed at ID inputs may be based on the configuration of the sensors. An example of such translations for a number of sensors and coupling configuration of the sensors is shown below in Table 1.

TABLE I
TRANSLATION OF RESISTANCE MEASURED AT ID INPUTS

| | Coupling Configuration | |
|---|---|---|
| Number of Sensors | Between Sensors | Translated Resistance |
| 1 | Not applicable | Sensed resistance |
| 2 | Series | Sensed resistance/2 |
| 2 | Parallel | Sensed resistance × 2 |
| 3 | Series | Sensed resistance/3 |
| 3 | Parallel | Sensed resistance × 3 |
| 4 | Series | Sensed resistance/4 |
| 4 | Parallel | Sensed resistance × 4 |
| 5 | Series | Sensed resistance/5 |
| 5 | Parallel | Sensed resistance × 5 |
| 6 | Series | Sensed resistance/6 |
| 6 | Parallel | Sensed resistance × 6 |
| 7 | Series | Sensed resistance/7 |
| 7 | Parallel | Sensed resistance × 7 |
| 8 | Series | Sensed resistance/8 |
| 8 | Parallel | Sensed resistance × 8 |
| 9 | Series | Sensed resistance/9 |
| 9 | Parallel | Sensed resistance × 9 |

The translation described above with respect to Table I is illustrative. In some embodiments, more than nine (9) sensors may be used. In terms of formulas, when the sensors are coupled together in series, the translated resistance may be calculated as the sensed resistance divided by the number of sensors. When the sensors are coupled together in parallel, the translated resistance may be calculated as the sensed resistance multiplied by the number of sensors. In some embodiments, a thermostat may store one or more formulas that may be used to calculate the translated resistance. In some embodiments, the thermostat may access the formulas via, e.g., one or more networks.

The examples described above in connection with FIGS. 2A-2C and Table I are illustrative. One of skill in the art would appreciate that the formulas for calculating the translated resistance may be modified from what is described above to accommodate configurations incorporating a combination of parallel and series coupled sensors. For example, in some embodiments a first subset of sensors may be coupled to one another in series, and the first subset may in turn be coupled in parallel to: (a) one or more other sensors, and/or (b) additional subset(s) of sensors that may be coupled in series. More generally, any physical arrangement of components or sensors may be employed with an accompanying adjustment to, or establishment of, a formula to calculate a translated resistance.

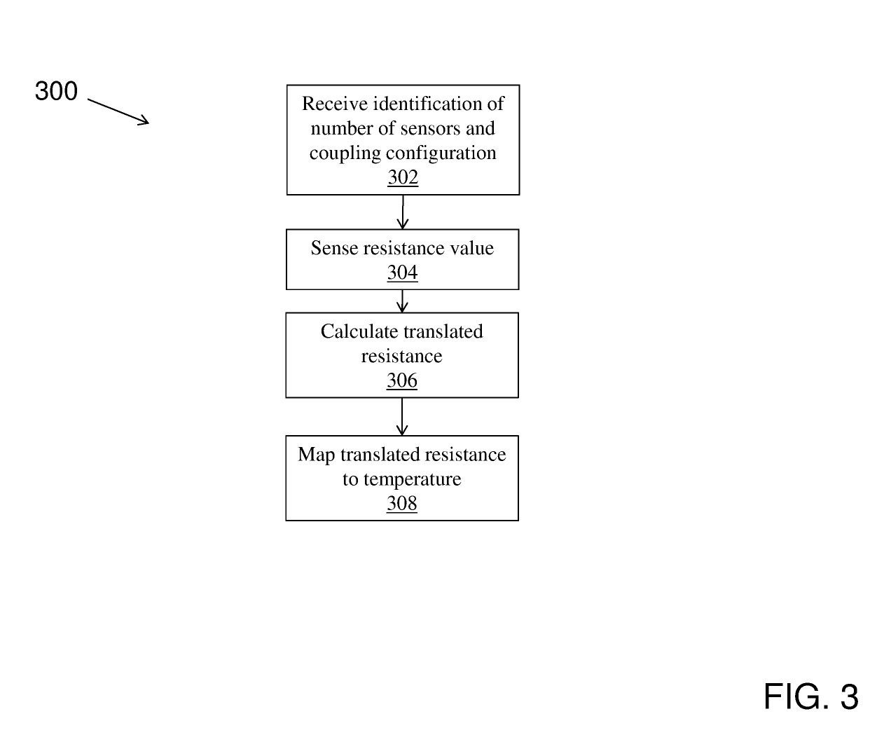

Turning to FIG. 3, a flow chart of a method 300 is shown. The method 300 may be executed in connection with one or more components, devices, or systems, such as those described herein. The method may be used to calculate a temperature associated with, or sensed by, one or more sensors. The method 300 may be implemented by the computing system 100 incorporated in the thermostat 202.

In block 302, an identification of a number of sensors used and a coupling configuration may be received at a device, such as a thermostat. In this regard, the thermostat may include an I/O or user interface, such as one or more setup screens, menus, buttons, keys, etc., to facilitate entry of such identifying data/information. In some embodiments, the I/O or user interface may be remotely located from the thermostat.

In block 304, the thermostat may sense, obtain, or measure a resistance value. The resistance value may be derived from the resistances associated with the sensors that have been employed and identified in block 302.

In block 306, based on the measured resistance of block 304 and the identification of block 302, an effective or translated resistance may be calculated. The translated resistance may be calculated using one or more formulas as described above.

In block 308, the translated resistance calculated in block 306 may be mapped or correlated to a temperature. For example, the translated resistance may be applied to a resistance-versus-temperature curve or the like to obtain the temperature. The curve may be stored at the thermostat or accessed by the thermostat via, e.g., one or more networks.

In some embodiments, one or more of the blocks or operations (or a portion thereof) of the method 300 may be optional. In some embodiments, the blocks may execute in an order or sequence different from what is shown in FIG. 3. In some embodiments, one or more additional blocks or operations not shown may be included. For example, in some embodiments, one or more values for inputs, one or more resistance values (e.g., measured and/or translated), and/or one or more temperatures may be presented to an I/O device (e.g., a display device). Such presentation may be used to facilitate troubleshooting or debugging activities at, e.g., the thermostat.

Embodiments of this disclosure may be tied to one or more particular machines. For example, one or more sensors may provide a resistance value that may be indicative of a sensed temperature. The resistance values may be combined or averaged by a device (e.g., a thermostat), where the combination of the resistance values may be based on the number of sensors used and the configuration or coupling of the sensors. In this respect, a combining or averaging in terms of temperature may be obtained by the device. More generally, a sensed parameter may be translated and mapped to a temperature.

Illustrative examples described herein relate aspects of this disclosure to a thermostat and sensors. The thermostat and sensors may be used in a variety of applications, such as refrigeration, ovens, heating, ventilation, and air-conditioning (HVAC) appliances (e.g., furnaces, boilers, heat pumps, air handlers, package units), and ranges. Aspects of the disclosure may be incorporated in controls (e.g., electronic controls) that run these types of units and would not be restricted to thermostats only.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors, and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A method comprising:
receiving, by a device, an identification of a coupling configuration associated with at least one sensor via a user interface;
sensing, by the device, a sensed parameter associated with the at least one sensor;
calculating, by the device, a translated parameter based on the sensed parameter; and
mapping, by the device, the translated parameter to a temperature.

2. The method of claim 1, wherein the device comprises a thermostat.

3. The method of claim 1, wherein the at least one sensor comprises a thermistor.

4. The method of claim 1, wherein the at least one sensor is remotely located from the device.

5. The method of claim 1, wherein the at least one sensor comprises a plurality of sensors.

6. The method of claim 5, wherein the coupling configuration indicates that the plurality of sensors are coupled to one another in series.

7. The method of claim 6, wherein calculating the translated parameter comprises dividing the sensed parameter by the number of sensors included in the plurality of sensors.

8. The method of claim 5, wherein the coupling configuration indicates that the plurality of sensors are coupled to one another in parallel.

9. The method of claim 8, wherein calculating the translated parameter comprises multiplying the sensed parameter by the number of sensors included in the plurality of sensors.

10. The method of claim 1, further comprising:
receiving, by the device, an identification of a number of sensors included in the at least one sensor via the user interface,
wherein the calculation of the translated parameter is based on the number of sensors.

11. An apparatus comprising:
at least one processor; and
memory having instructions stored thereon that, when executed by the at least one processor, cause the apparatus to:
receive an identification of a coupling configuration associated with at least one sensor via a user interface,
sense a resistance value associated with the at least one sensor,
calculate a translated resistance value based on the sensed resistance, and
map the translated resistance to a temperature.

12. The apparatus of claim 11, wherein the at least one sensor comprises a plurality of sensors.

13. The apparatus of claim 12, wherein the coupling configuration indicates that the plurality of sensors are coupled to one another in series.

14. The apparatus of claim 13, wherein the instructions, when executed by the at least one processor, cause the apparatus to:
calculate the translated resistance by dividing the sensed resistance by the number of sensors included in the plurality of sensors.

15. The apparatus of claim 12, wherein the coupling configuration indicates that the plurality of sensors are coupled to one another in parallel.

16. The apparatus of claim 15, wherein the instructions, when executed by the at least one processor, cause the apparatus to:
calculate the translated resistance by multiplying the sensed resistance by the number of sensors included in the plurality of sensors.

17. The apparatus of claim 11, wherein the instructions, when executed by the at least one processor, cause the apparatus to:
receive an identification of a number of sensors included in the at least one sensor via the user interface,
wherein the calculation of the translated resistance is based on the number of sensors.

18. A system comprising:
a plurality of temperature sensors; and
a thermostat remotely located from the plurality of temperature sensors, the thermostat configured to:
receive an identification of a number of sensors included in the plurality of temperature sensors and a coupling configuration between the plurality of temperature sensors via a user interface,
sense a resistance value associated with the plurality of temperature sensors,
calculate a translated resistance value based on the sensed resistance, the number of sensors included in the plurality of temperature sensors, and the coupling configuration, and
map the translated resistance to a temperature.

19. The system of claim 18, wherein the system is associated with at least one of a refrigerator, an oven, a furnace, a boiler, a heat pump, an air handler, a package unit, and a range.

20. The system of claim 18, wherein the thermostat is configured to cause an identification of at least one of the number of sensors, the coupling configuration, the sensed resistance, the translated resistance, and the temperature to be displayed on a display device, and wherein the thermostat is configured to calculate the translated resistance using a formula, and wherein the formula is accessed from at least one of a memory coupled to the thermostat and a network.
